(19) United States
(12) Patent Application Publication
(10) Pub. No.: US 2010/0017628 A1
(43) Pub. Date: Jan. 21, 2010

(54) Systems for Using Different Power Supply Configurations with a Common Motherboard

(75) Inventors: Yu-Lin Chen, Sanchong City (TW); Chien Hua Pan, Zhubei City (TW); Chih Min Su, Sanchong City (TW); Chih Nan Lin, Zhubei City (TW)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 12/176,031

(22) Filed: Jul. 18, 2008

(51) Int. Cl. G06F 1/26

(52) U.S. Cl. 713/300

(57) ABSTRACT

In some embodiments, an information handling system may include a motherboard including a processor and memory coupled to the processor; one or more power supply units configured to provide power to the motherboard; and a connection system configured to deliver voltage from the one or more power supply units to the motherboard in both: (a) a first configuration including a single power supply unit providing power to the motherboard; and (b) a second configuration including multiple power supply units providing power to the motherboard.

### TECHNICAL FIELD

The present disclosure relates to system power supplies, and more particularly, supporting a single power supply unit and/or a redundant power supply configuration with a common motherboard.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as, but not limited to, financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems are generally powered by a power supply unit that receives and converts alternating current (AC) power to direct current (DC) power that is then used to power one or more components of the information handling system. In some information handling systems, a redundant power supply system including more than one power supply unit (PSU) may be used to improve the availability and reliability of the power supply system. Typically, in a redundant power supply configuration, multiple PSUs may be coupled together and share a load such that in the event of a failure of a single power supply unit, the failure may not substantially affect the delivery of power to the components of the information handling system.

Many current systems utilize a power distribution board (PDB) that distributes power from one or more power supplies to components of an information handling system. However, different PDBs and motherboards are used for a single power supply unit versus a redundant power supply unit configuration. Thus, in situations that involve changing from a single power supply unit to a redundant power supply system or vice versa (e.g., a power system upgrade or a power supply system repair), the motherboard and/or PDB must be swapped out, which may be expensive, time consuming, and/or impractical.

### SUMMARY

In one embodiment, an information handling system may include a motherboard including a processor and memory coupled to the processor; one or more power supply units configured to provide power to the motherboard; and a connection system configured to deliver voltage from the one or more power supply units to the motherboard in both: (a) a first configuration including a single power supply unit providing power to the motherboard; and (b) a second configuration including multiple power supply units providing power to the motherboard.

In some embodiments, a connection system for connecting one or more power supply units to a motherboard in an information handling system is provided. The connection system may include a power distribution board and one or more connectors, wherein the power distribution board and the one or more connectors cooperate to provide voltage from one or more power supply units to a motherboard in both: (a) a first configuration including a single power supply unit providing power to the motherboard; and (b) a second configuration including multiple power supply units providing power to the motherboard.

In other embodiments, an information handling system may include a motherboard comprising a processor and memory coupled to the processor; a connection system configured to deliver voltage from one or more power supply units to the motherboard in both: (a) a first configuration including a single power supply unit providing power to the motherboard; and (b) a second configuration including multiple power supply units providing power to the motherboard; and a chassis defining a common chassis area configured to (a) receive a first type of support structures configured to support the single power supply unit in the first configuration, and (b)receive a second type of support structures configured to support the multiple power supply units in the second configuration.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system including a system for using different power source configurations with the same motherboard, in accordance with certain embodiments of the present disclosure;

FIGS. 2A-2C illustrate example connections between various different power supply unit configurations and a power distribution board, in accordance with certain embodiments of the present disclosure;

FIG. 3 illustrate an example information handling system chassis including a first type cage for housing a single power supply unit, in accordance with certain embodiments of the present disclosure;

FIGS. 4A and 4B illustrate the example information handling system chassis of FIG. 3, including a second type of cage for housing a redundant power supply configuration, in accordance with certain embodiments of the present disclosure; and

FIG. 5 illustrates the example information handling system chassis of FIG. 3 and other components of an information handling system, in accordance with certain embodiments of the present disclosure.

### DETAILED DESCRIPTION

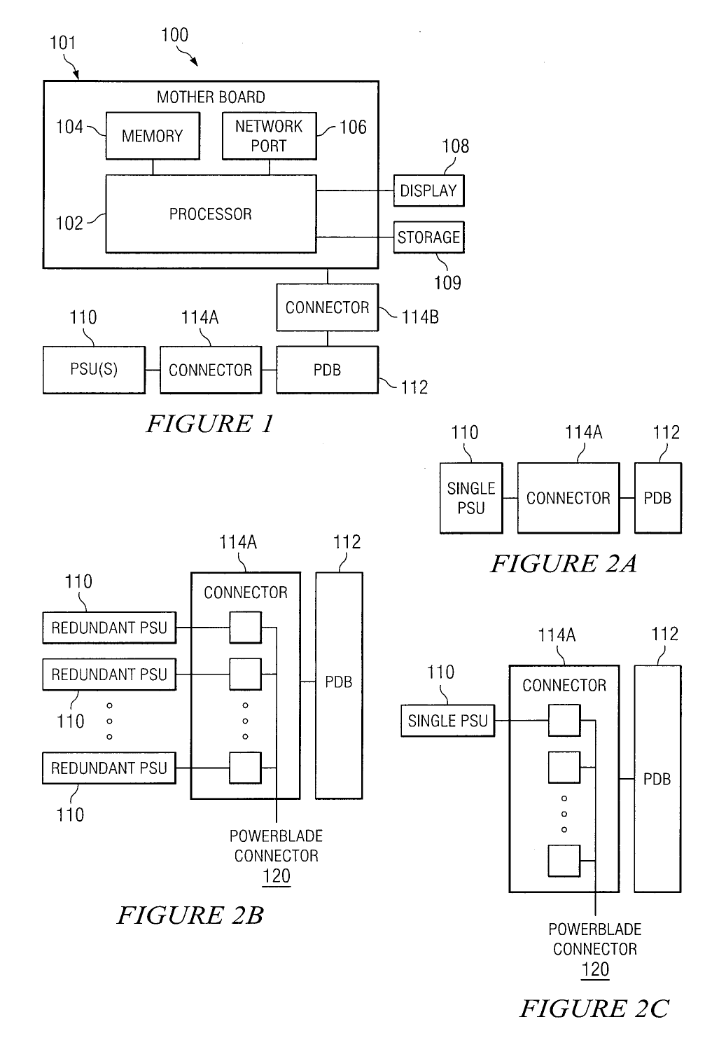

Preferred embodiments and their advantages are best understood by reference to FIGS. 1-5, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and/or a video display. The information handling system may also include one or more buses operable to transmit communications between the various hardware components.

FIG. 1 illustrates a block diagram of an example information handling system 100 including a system for using different power source configurations with the same motherboard, in accordance with certain embodiments of the present disclosure. As shown in FIG. 1, information handling system 100 may include a motherboard 101, a display 108, a storage device 109, one or more power supply units 110, a power distribution board (PDB) 112, and connectors 114A and 114B.

Motherboard 101 may be a printed circuit board housing one or more electrical components of information handling system including, for example, a processor 102, memory 104, and/or a network port 106. Motherboard 101 may provide electrical connection (e.g., communicate data and control signals) over signal buses between various electrical components of information handling system 100.

Processor 102 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104, storage device 109, and/or another component of information handling system 100 and may output results, graphical user interfaces (GUIs), websites, and the like via display 108 or over network port 106.

Memory 104 may be coupled to processor 102 and may comprise any system, device, or apparatus operable to retain program instructions or data for a period of time. Memory 104 may comprise random access memory (RAM), electrically erasable programmable read-only memory (EEPROM), a PCMCIA card, flash memory, or any suitable selection and/or array of volatile or non-volatile memory that retains data after power to information handling system 100 is turned off.

Network port 106 may be any suitable system, apparatus, or device operable to serve as an interface between information handling system 100 and a network. Network port 106 may enable information handling system 100 to communicate over a network using any suitable transmission protocol and/or standard, including without limitation all transmission protocols and/or standards known in the art.

Display 108 may comprise any display device suitable for creating graphic images and/or alphanumeric characters recognizable to a user, and may include, for example, a liquid crystal display (LCD) or a cathode ray tube (CRT).

Storage device 109 may comprise any system, device, or apparatus configured to retain program instructions or data for a period of time. For example, storage device 109 may be a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory, as well as communications media such wires, optical fibers, microwaves, radio waves, and other electromagnetic and/or optical carriers, and/or any combination of the foregoing.

One or more power supply units (PSUs) 110 may include any device, system, or apparatus operable to supply power or electrical energy to one or more components of information handling system 100. For example, each power supply unit 110 may include any system, device, and/or apparatus operable to supply direct current (DC) electrical power to one or more components of information handling system 100. In some embodiments, a DC power supply unit may comprise a battery. In the same or alternative embodiments, a DC power supply unit may comprise an AC/DC adapter that may convert 120- or 240-volt (or any other suitable voltage) alternating current supplied by a utility company to a regulated lower voltage DC power supply unit. In addition, an AC/DC adapter may also charge a battery while supplying power to information handling system 100.

In addition or alternatively, power supply unit(s) 110 may include any system, device, and/or apparatus operable to supply AC electrical power directly to one or more components of information handling system 100. In some embodiments, the AC power supply unit may subsequently be converted into a DC power supply unit (e.g., using an AC/DC converter).

In some embodiments, power supply unit(s) 110 may include an uninterruptible power supply unit or a switch mode power supply unit. In other embodiments, power supply units 110 may be configured in a redundant configuration (e.g., multiple power supply units may be configured to share a load such that failure of a single power supply unit may not substantially affect the system operation) within, for example, a chassis associated with information handling system 100. Alternatively, power supply units 110 may include an array of power supply units, e.g., an array of programmable DC power sources.

Power distribution board (PDB) 112 may be coupled to power supply unit(s) 110 and/or motherboard 101 via one or more connectors 114 (e.g., connectors 114A and 114B, discussed below), and may include any hardware, firmware, and/or software for distributing power from power supply unit(s) 110 to other components of information handling system 100. In some embodiments, power distribution board 112 may include printed circuits having one or more conductive layers that may relay AC voltage(s), DC voltage(s), and/or a ground voltage to components of information handling system 100.

Power distribution board 112 may be configured for various power system configurations used in information handling system 100. In one embodiment, power distribution board 112 may be configured to distribute one or more voltages provided from a single power supply 110 to various components of information handling system 100. In the same or alternative embodiments, power distribution board 112 may be configured to distribute one or more voltages from multiple power supply units 110 (e.g., arranged in a redundant configuration) to various components of information handling system 100.

Each connector 114 may be a goldfinger connector or other suitable connector that may relay voltages supplied by the one or more power supply units 110 through power distribution board 112 to the components of motherboard 101 and/or other components of information handling system 100. One type of connector 114 may be configured to connect a single power supply unit 110 to power distribution board 112. Another type of connector 114 may be configured to connect multiple power supply units 110 (e.g., two or more power supply units 110 configured in a redundant configuration) to power distribution board 112. This latter type of connector 114 may also be capable of connecting a single power supply unit 110 to power distribution board 112.

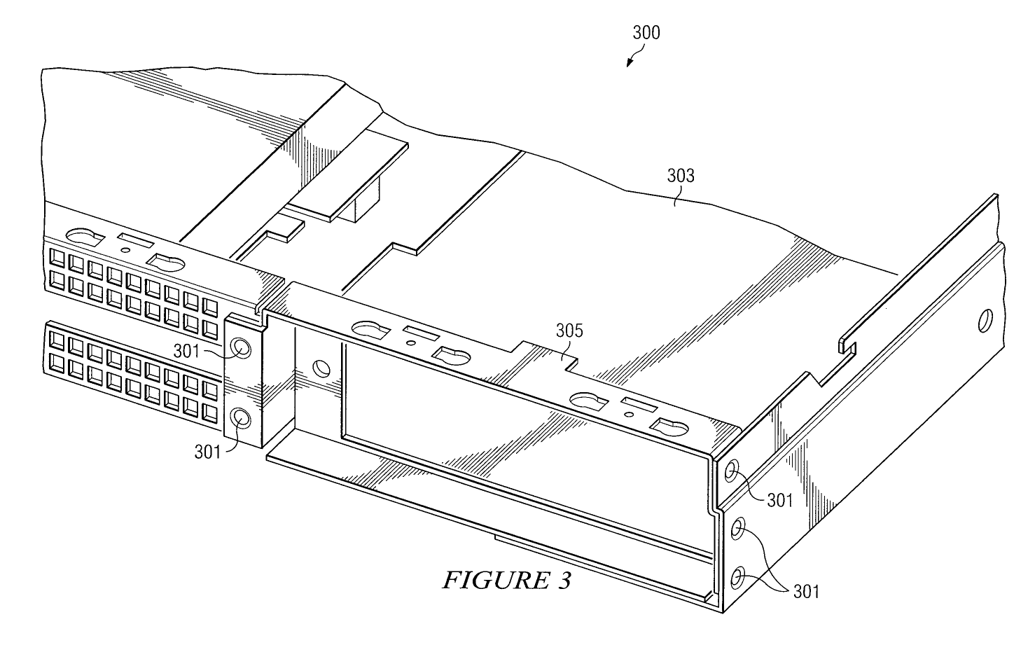

FIGS. 2A through 2C illustrate example connections between various different power supply unit configurations and power distribution board 112, in accordance with certain embodiments of the present disclosure.

FIG. 2A illustrates a first type of connector 114A configured to provide voltages from a single power supply unit 110 to a first type of power distribution board 112.

FIG. 2B illustrates a second type of connector 114A configured to provide voltages from a redundant power system (e.g., multiple power supply units 110 arranged in a redundant configuration) to a second type of power distribution board 112 configured to distribute one or more voltages from multiple power supply units 110. Second connector 114A may include multiple power blade connectors 120, each coupled to one power supply unit 110 of the redundant power system.

FIG. 2C illustrates the second type of connector 114A of FIG. 2B configured to provide voltages from a single power supply unit 110 to the second type of power distribution board 112. The single power supply unit 110 may be coupled to one of the multiple power blade connectors 120.

Using the first and/or second types of connectors 114A and/or first and/or second types of power distribution board 112 as appropriate allows power supply unit(s) 110 to be updated, replaced, or otherwise changed without changing motherboard 101.

Connector 114B may be a goldfinger connector or other suitable connector to couple power distribution board 112 to motherboard 101. In some embodiments, connector 114B is configured to connect different numbers of power supply unit(s) 110 (e.g., a single power supply unit configuration or a redundant power supply unit configuration) to motherboard 101 without having to swap out connector 114B, motherboard 101, and/or associated power cables.

In operation, power supply unit(s) 110 may be upgraded, swapped, and/or replaced in information handling system 100 by coupling power supply unit(s) 110 to connector 114A. If connector 114A is not suitable for the current number of power supply units 110 (e.g., connector 114A may not include enough power blade connectors 120), and/or if power distribution board 112 may not be suitable for the current power supply configuration (e.g., power distribution board 112 may not be configured to distribute the power supplied by power supply unit(s) 110), connector 114A and/or power distribution board 112 may be replaced or swapped out without having to remove or swap out motherboard 101.

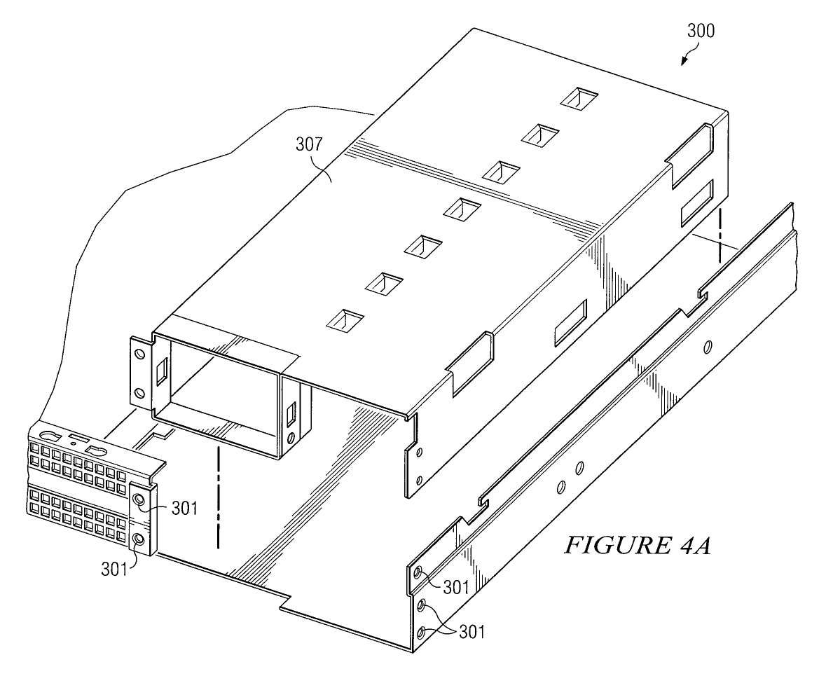

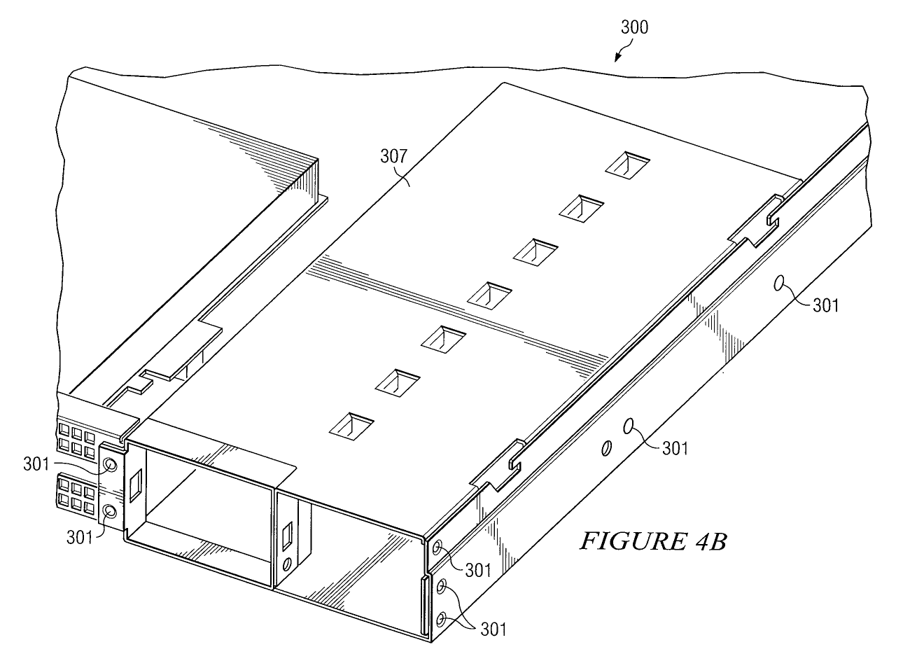

Some or all components of information handling system 100 may be housed in a chassis. For example, motherboard 101, processor 102, memory 104, storage device 109, power supply unit(s) 110, power distribution board (PDB) 112, and/or connectors 114A and 114B may be housed within the chassis. The chassis may include a common chassis area that may be configured to receive various power supply configurations (e.g., a single power supply unit 110 or multiple power supply units 110 configured in a redundant configuration). Different housing and support structures may be used to support the different power supply configuration housed in the common chassis area. For example, a common chassis area 303 shown in FIGS. 3, 4A, and 4B may be used for supporting one or more power supply units as discussed below.

FIG. 3 illustrates an example information handling system chassis 300 including a first type of cage 305 for housing a single power supply unit, in accordance with certain embodiments of the present disclosure. Chassis 300 may include a common chassis area 303 configured to receive one or more power supply units 110, depending on the desired configuration. As discussed above, different support and/or connecting structures (e.g., cages 305 and 307 discussed herein) may be disposed in common chassis area 303 depending on the desired power supply unit configuration (e.g., a single power supply configuration or a multiple power supply configuration). For example, in the configuration shown in FIG. 3, a single power supply unit 110 may be secured to chassis 300 via a first type of cage 305, joints 301, screws, and/or other fastening means.

FIGS. 4A and 4B illustrate the example information handling system chassis 300 from FIG. 3 but including a second type of cage 307 configured to house a redundant power supply unit configuration, in accordance with certain embodiments of the present disclosure. In this configuration, two or more power supply units 110 may be secured to chassis 300 via the second type of cage 307. For example, cage 307 may be provided over the power supply units 110 to secure the power supply units to chassis 303.

FIG. 4B shows cage 307 placed over common chassis area 303 and secured to chassis 300 in a similar fashion as cage 305 shown in FIG. 3. For example, cage 307 may be secured to chassis 300 using joints 301, screws, and/or other fastening means.

As shown, cage 305 of FIG. 3 and cage 307 of FIGS. 4A and 4B may have a similar dimension in at least one direction so that cage 305 or cage 307 may be fitted to chassis 300 without having to change the chassis.

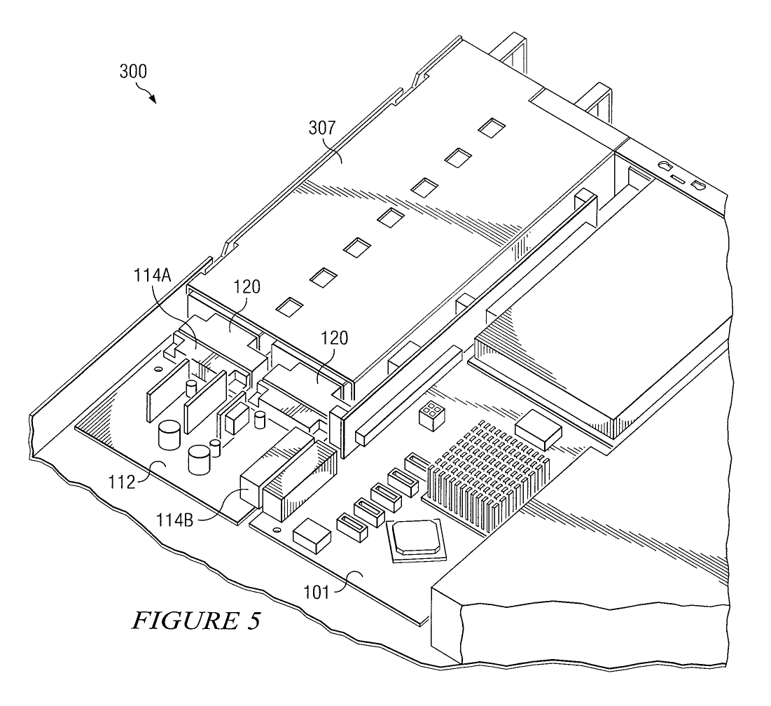

FIG. 5 illustrates an example information handling system chassis 300 housing some components of information handling system 100, in accordance with certain embodiments of the present disclosure. Cage 307 for encasing multiple power supply units 110 may be coupled to power distribution board 112 via connector 114A having one or more power blade connectors 120. Power distribution board 112 may be coupled to motherboard 101 via connector 114B.

In certain embodiments, cage 307 may be removed and replaced with cage 305 used to secure a single power supply unit 110 to chassis 300. Single power supply unit 110 may be connected to motherboard 101 via connectors 114 and power distribution board 112. In some embodiments, the same connector 114A may be used to connect both multiple power supply units 110 and/or a single power supply unit 110 to power distribution board 112. In other embodiments, different connectors 114A may be used to connect a single power supply unit versus multiple power supply units to power distribution board 112.

The present disclosure provides systems for upgrading and/or replacing different power system configuration (e.g., a single power supply unit to a redundant power system configuration, a redundant power system to a single power supply unit, etc.) using a common chassis area configured to receive the different power system configuration. Additionally, connectors 114 and/or power distribution board 112 may be replaced to accommodate the various power system configurations, without having to update and/or replace motherboard 101.

Although the present disclosure has been described in detail, it should be understood that various changes, substitutions, and alterations can be made hereto without departing from the spirit and the scope of the invention as defined by the appended claims.

What is claimed is:

1. An information handling system, comprising:
a motherboard including:
a processor; and
memory coupled to the processor;
one or more power supply units configured to provide power to the motherboard;
a connection system configured to deliver voltage from the one or more power supply units to the motherboard in both:
(a) a first configuration including a single power supply unit providing power to the motherboard; and
(b) a second configuration including multiple power supply units providing power to the motherboard.

2. The information handling system of claim 1, wherein the connection system comprises a power distribution board and one or more connectors.

3. The information handling system of claim 2, wherein the one or more connectors comprise a connector coupled between the one or more power supply units and the power distribution board.

4. The information handling system of claim 2, wherein the one or more connectors comprise a plurality of power blade connectors for coupling the multiple power supply units in the second configuration to the power distribution board.

5. The information handling system of claim 2, wherein the one or more connectors comprise one or more goldfinger connectors.

6. The information handling system of claim 2, wherein the information handling system can be switched from the first configuration to the second configuration and from the second configuration to the first configuration without swapping out either the power distribution board or the motherboard.

7. The information handling system of claim 1, wherein the information handling system can be switched from the first configuration to the second configuration and from the second configuration to the first configuration without swapping out the motherboard.

8. The information handling system of claim 1, wherein the multiple power supply units are configured in a redundant power supply configuration.

9. The information handling system of claim 1, further comprising a chassis configured to house the motherboard, the one or more power supply units, and the connection system;
wherein the chassis comprises a common chassis area for housing either the first configuration or the second configuration.

10. A connection system for connecting one or more power supply units to a motherboard in an information handling system, the connection system comprising:
a power distribution board; and
one or more connectors; and
wherein the power distribution board and the one or more connectors cooperate to provide voltage from one or more power supply units to a motherboard in both:
(a) a first configuration including a single power supply unit providing power to the motherboard; and
(b) a second configuration including multiple power supply units providing power to the motherboard.

11. The connection system of claim 10, wherein the one or more connectors comprise a plurality of power blade connectors configured to connect each of the multiple power supply units in the second configuration to the power distribution board.

12. The connection system of claim 10, wherein the multiple power supply units are configured in a redundant power supply configuration.

13. The connection system of claim 10, wherein the information handling system can be switched from the first configuration to the second configuration and from the second configuration to the first configuration without swapping out the motherboard.

14. The connection system of claim 10, wherein the information handling system can be switched from the first configuration to the second configuration and from the second configuration to the first configuration without swapping out either the power distribution board or the motherboard.

15. The connection system of claim 10, further comprising a chassis configured to house the motherboard, the one or more power supply units, and the connection system; wherein the chassis comprises a common chassis area for housing either the first configuration or the second configuration.

16. An information handling system, comprising:
a motherboard including:
a processor; and
memory coupled to the processor;
a connection system configured to deliver voltage from one or more power supply units to the motherboard in both:
(a) a first configuration including a single power supply unit providing power to the motherboard; and
(b) a second configuration including multiple power supply units providing power to the motherboard; and
a chassis defining a common chassis area configured to:
receive a first type of support structures configured to support the single power supply unit in the first configuration; and
receive a second type of support structures configured to support the multiple power supply units in the second configuration.

17. The information handling system 16, wherein:
the first type of support structures comprises a first type of cage configured to support the single power supply unit in the first configuration; and
the second type of support structures comprises a second type of cage configured to support the multiple power supply units in the second configuration.

18. The information handling system of claim 16, wherein the connection system comprises a power distribution board and one or more connectors.

19. The information handling system of claim 18, wherein the one or more connectors comprise a plurality of power blade connectors for coupling each of the multiple power supply units in the second configuration to the power distribution board.

20. The information handling system of claim 16, wherein the information handling system can be switched from the first configuration to the second configuration and from the second configuration to the first configuration without swapping out the motherboard.
